(19) United States
(12) Patent Application Publication
(10) Pub. No.: US 2019/0094995 A1
(43) Pub. Date: Mar. 28, 2019

(54) Mouse for Smartphone Worn on the Finger

(71) Applicant: Amit Ohayon, Rehovot (IL)

(72) Inventor: Amit Ohayon, Rehovot (IL)

(21) Appl. No.: 16/143,448

(22) Filed: Sep. 26, 2018

(30) Foreign Application Priority Data
Sep. 28, 2017 (IL) 254764

(51) Int. Cl. G06F 3/0354

(52) U.S. Cl. CPC G06F 3/03543

(57) ABSTRACT

A mouse for smartphone that is designed to be worn on the finger of the user. The mouse includes a foldable mat, an inner battery, and a communication unit. The foldable mat includes fasteners that are designed to secure the foldable mat (2) on the finger of the user when the mouse in use. The bottom side of the foldable mat includes a Led mechanism that is designed to detect the relative movement of the mouse, and a first mouse button. The upper side of the foldable mat includes a second mouse button.

### TECHNICAL FIELD

The present invention refers to a computer mouse for smartphone which is designed to be worn on the finger of the user.

### BACKGROUND ART

When a person uses his smartphone that have touch screen he needs to use his fingers, usually the index finger, repeatedly over and over the screen for scrolling and navigating. This repeated finger action causes discomfort, pain and problems to the finger, and in addition forces the user to hold the smartphone in his hand, usually the second hand, thus, his both hands are busy in these actions. The present patent application discloses a computer mouse for smartphone which is designed to be worn on the finger of the user that provides good solution for these problems.

### DESCRIPTION OF THE DRAWINGS

The intention of the drawings attached to the application is not to limit the scope of the invention and its application. The drawings are intended only to illustrate the invention and they constitute only one of its many possible implementations.

FIG. 1 depicts the bottom side (22) of the foldable mat (2) in flat position.

FIG. 2 depicts the upper side (23) of the foldable mat (2) in flat position.

FIG. 3 is a side view of the mouse (1) in folded position.

FIG. 4 is a top view of the mouse (1) in folded position.

FIG. 5 depicts the docking station (100) and the mouse (1).

FIG. 6 depicts the docking station (100) where opened and contain the mouse.

FIG. 7 depicts the docking station (100) when it is closed.

FIG. 8 depicts the mouse (1) worn on a finger.

### THE INVENTION

The object of the present invention is to provide a computer mouse for smartphone (1) that is designed to be worn on the finger of the user.

The mouse (1) includes a foldable mat (2) wherein said mat includes fasteners (3), such as magnets, snap buttons, Hook-and-loop fastener and the like. The foldable mat (2) is shaped in a way that when it is wrapped and fastened on the finger its shape turns to cylinder, wherein the nail may protrude through its front opening (24). The fasteners (3) are designed to secure the foldable mat (2) on the finger when the mouse (1) in use. The mouse (1) may also include an enlargement strip (21) for cases when the user has quite wide finger and said enlargement strip (21) has corresponding fasteners (3) too. The mouse (1) also includes inner rechargeable battery (11) and communication unit (12) for communication with the smartphone through short range communication link. It is possible that a smartphone application will be used to activate and operate the mouse (1) and the communication with the smartphone itself.

The bottom side (22) of the foldable mat (2) includes a Led mechanism (3) that is designed to detect the relative movement of the mouse (1), which its structure and function are in general the same as of standard optical mice. The bottom side (22) also includes a first mouse button (51) possible on the right side of the foldable mat (2) wherein this first mouse button (51) is positioned on the right side of the mouse (1) when in use and by that enabling the user to click on it by pressing his middle finger to the index finger on which the mouse (1) is worn, or on the left side when the user can click on it by his thumb.

The upper side (23) of the foldable mat (2) includes a second mouse button (52) preferably on its front center side wherein preferably the second mouse button (52) is positioned under the distal phalanx of the index finger on which the mouse is worn and by that enabling the user to click on it by pressing downward his distal phalanx of the index finger.

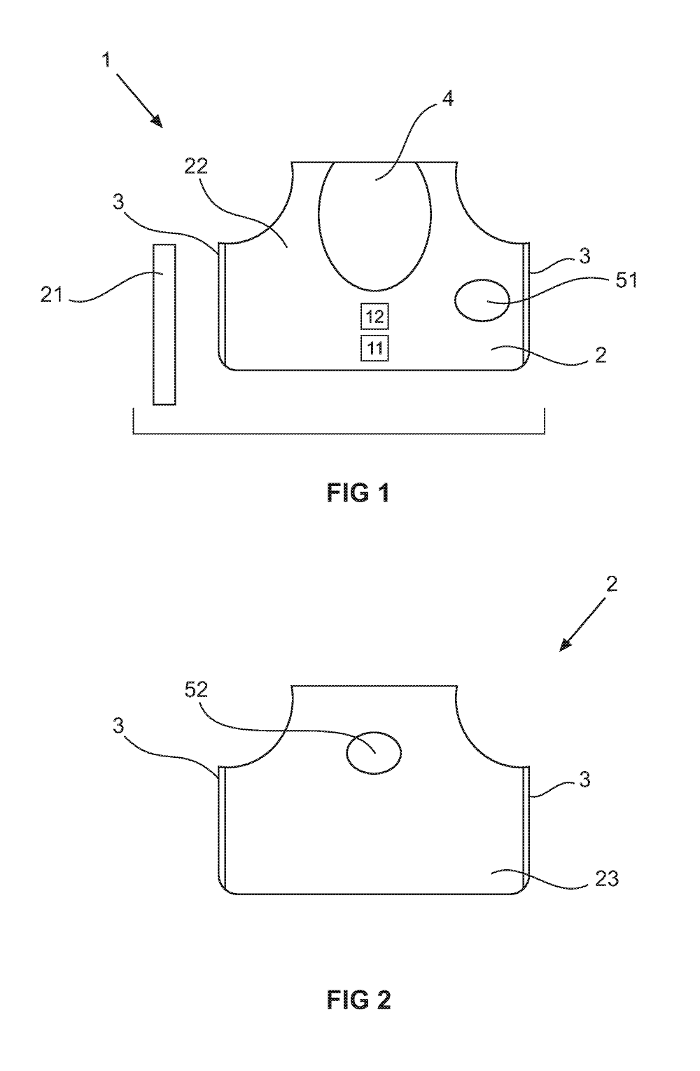

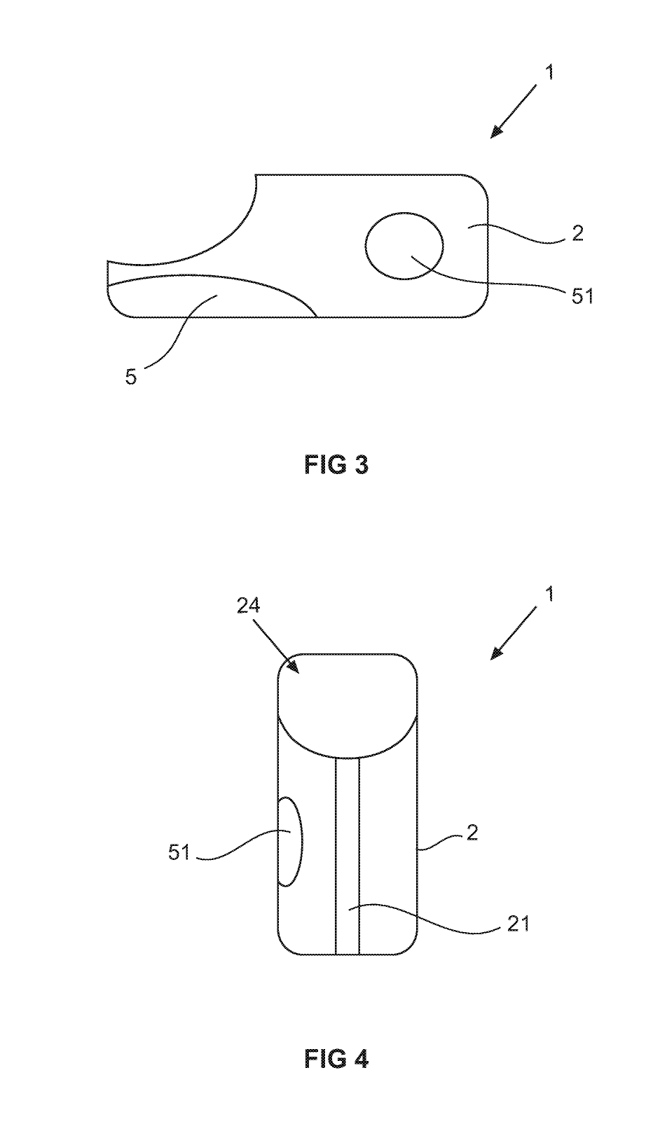

FIG. 1 depicts the bottom side (22) of the foldable mat (2) in flat opened position; FIG. 2 depicts the upper side (23) of the foldable mat (2) in flat opened position; FIG. 3 is a side view of the mouse (1) in folded position; and FIG. 4 is a top view of the mouse (1) in folded position.

The first mouse button (51) and the second mouse button (52) are designed to be programmed in a way that pressing or clicking on one of them, or in combination of both, in several variations, provide the functions of standard computer mouse such as scrolling and navigating and may also additional functions relevant for smartphone, such as, accepting or rejecting phone calls, activating the camera and the like.

The computer mouse for smartphone (1) enables the user to operate the smartphone with almost free hands. The mouse (1) enables the user to lay the smartphone on a table for example and to operate it while the hand with the finger on which the mouse (1) is worn can move and positioned freely. The user can operate the mouse (1) simply by sliding it over his knees for example or any other object. Using the mouse (1) make it unnecessary to touch the screen by the finger over and over. The computer mouse for smartphone (1) may be used also for operating standard computers and by that enabling the user to control it when his hands are quite free.

The present patent application also refers to a docking station (100) in which the mouse (1) in flat opened position may be stored when not in use. The docking station (100) includes a flat casing (101) and charging terminal (102) for charging the mouse (1). The docking station (100) may also include an attachment means (103) for attaching the casing (101) to the back side of the smartphone. Such attachment means (103) may be a double sided adhesive for example.

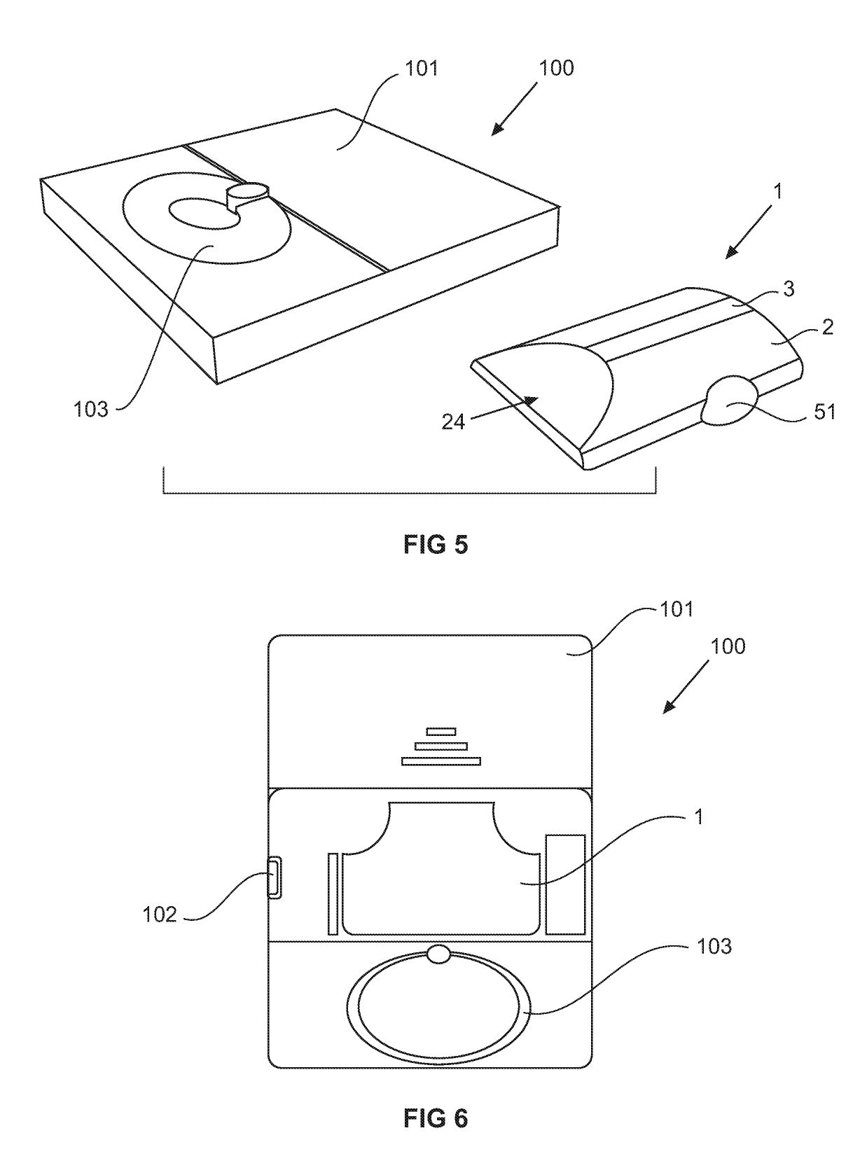

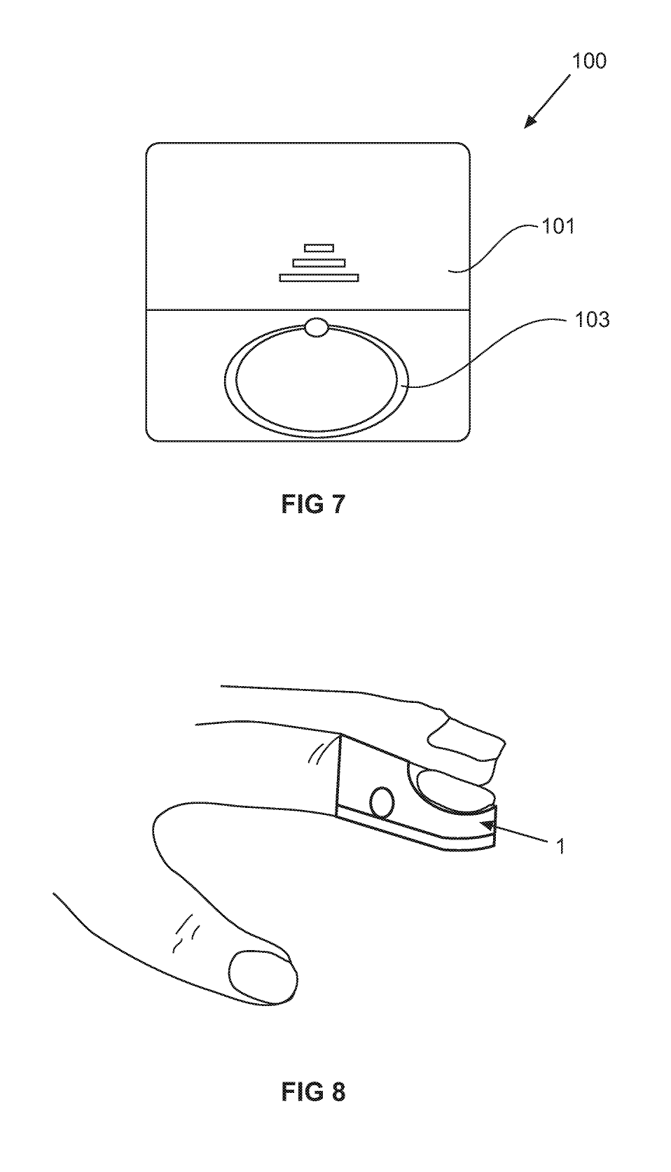

FIG. 5 depicts the docking station (100) and the mouse (1); FIG. 6 depicts the docking station (100) when it is opened and containing the mouse (1); FIG. 7 depicts the docking station (100) when it is closed; and FIG. 8 depicts the mouse (1) worn on a finger.

The term “smartphone” in this application and in the claims refers to any kind of device that is designed or that it is possible to control it fully or in part with remote control, such as computers, electric or electronic machines, desktop computers, laptops, tablets, mobile phone and smartphones. Using the mouse (1) subject matter of the present invention with these kinds of devices will provide the advantageous that stated in the preamble of the application.

What is claimed is:

1. A mouse for smartphone that is designed to be worn on a finger of a user, comprising: a foldable mat, an inner battery, and a communication unit; wherein the foldable mat includes fasteners that are designed to secure the foldable mat on the finger of the user when the mouse for smartphone in use; wherein a bottom side of the foldable mat includes a Led mechanism that is designed to detect the relative movement of the mouse for smartphone, and a first mouse button; and wherein an upper side of the foldable mat includes a second mouse button.
